(19) United States
(12) Patent Application Publication
(10) Pub. No.: US 2003/0197856 A1
(43) Pub. Date: Oct. 23, 2003

(54) Refractometer (Milanich's tester)

(76) Inventor: Alexander Ivanovich Milanich, Moscow (RU)

Correspondence Address: Alexander Milanich, Studenetskij per. 6-51, Moscow, 123100, RU

(21) Appl. No.: 10/123,286

(22) Filed: Apr. 17, 2002

(51) Int. Cl. G01N 21/41

(52) U.S. Cl. 356/128

(57) ABSTRACT

The present invention relates to the field of medical technique, and more precisely relates to refractometers used for determining vision parameters. A refractometer of the present invention increases the accuracy of measuring vision parameters while simplifying refractometer design. This device can further be used to train the eye muscles using corresponding medical methodologies. The first embodiment of the refractometer comprises an optical focusing element (1), a test-object (2), an optical axis (3), and a measuring element (4). The optical focusing element is in optical alignment with the test-object, which in the case of a normal vision placed in the focus of the optical focusing element. The optical focusing element and the test-object are arranged so as to allow their mutual displacement along the optical axis.

### CROSS REFERENCE TO RELATED APPLICATIONS

1. Grushnikov Igor Anatolievich, Vision diagnostic by Grushnikov's method RU #2071716 C1, Class A61 B 3/028, published Jan. 20, 1997,

2. Tom N. Cornsweet, Method and Means for Relaxing the Accommodation of the Eye U.S. Pat. No. 3,843,240, Class A 61 B 3/12, (U.S. Cl. 351/2) published Oct. 22, 1974

3. Magarill S. Ya.et al, Refractometer SU #. 906508, Class A 61 B 3/103, published Feb. 23, 1982

### BACKGROUND OF THE INVENTION

1. Field of the Invention

The invention relates to medical instruments, more exactly to refractometers used for determination of vision parameters

2. Description of the Prior Art

One of the main characteristics of the eye is visual acuity, the ability to see fine details of objects. Visual acuity depends on the structure of retina, the contrast and the background of an observed object, a diameter of a pupil, defects of the vision, an illumination, etc. A unit of visual acuity defined as ability of an eye to see an object of 1 angular minute in dimension. The deviation from normal vision (nearsightedness, farsightedness) allows to see fine objects, but only at certain distances. Another deviation from the normal vision is color blindness, that is an inability to distinguish color hues of certain spectral ranges. Color blindness, as a rule, does not affects on visual acuity, if it does not cause for this person coincidence of the background color with the object's color. An impossibility of precise seeing of objects (images duplication), resulting from aspherical surface of the cornea, is called an astigmatism. Reduced eye accommodation, as the result of the crystalline lens muscles degeneration, or other abnormal conditions, causes difficulties in recognition of near and/or far objects.

There are known many methods and devices for measuring vision parameters.

Russian Federation Pat. No 2071716, Class A61 B 3/028, published Jan. 20, 1997, discloses the Grushnikov's method of vision diagnosis, where a distance between patient's eye and a distant object is measured when the patient can see the distant object clearly, and the measured distance is used to calculate vision parameters. However, this method allows to determine the power of corrective lenses, and very approximately an eye accommodation and astigmatism, for nearsightedness only, (impossible to apply for farsightedness).

U.S. Pat. No. 3,843,240, Class A 61 B 3/12, (U.S. Cl. 351/2) published Oct. 22, 1974, discloses a method and device for improvement of eye accommodation, wherein an eye looks at a point source located not in a focus of a lens, that causes the eye muscles work and relax, thus training the eye crystalline lens. This method of eye training allows correcting the vision, but does not measuring of vision parameters.

USSR Pat. No. 906508, published Feb. 23, 1982, Class A 61 B 3/103, discloses a refractometer, FIG. 2, for researching the eye refraction. This refractometer comprises a collimator objective 1, a test-object 2 coupled with a measuring scale 6, a movable optical member 7 and an eyepiece 8. The test-object is placed in the focus of the objective 1, and the collimator objective 1, the optical member 7, and the eyepiece 8 create an optical system aligned with the test-object 2 along an optical axis 3. With this refractometer a patient do the measurements of eye refraction, accommodation, and astigmatism himself and see results at a numerical scale graduated in dioptres. A patient, looking at the test-object 2 through the optical system, moves the optical member 7 to reach a clear image of the test-object 2. This method corresponds to, as if a person tries on different glasses to determine which are the best. However, as a rule, the patient prefers stronger glasses producing most of visual “comfort”, that introduces a systemic error adversely influencing on reliability of measurements of the patient's vision parameters. Another disadvantage is the complexity of the graduation of this device, because the graduation by calculations require a very exact knowledge of radiuses and refraction indexes of the collimating objective 1 and of the movable optical member 7. The slightest error in values of these optical parameters bears on accuracy of the scale graduation, and results in smaller accuracy and reliability.

### SUMMARY OF THE INVENTION

Accordingly, the purpose of this invention is to provide an affordable optometric device for measuring vision parameters, namely, a refractometer device having a better accuracy of measurement vision parameters, such as the myopia or the hyperopia, diopter values of corrective lenses, the accommodation and astigmatism, with ability to check color vision sensitivity, while simultaneously simplifying the refractometer design. Additionally, disclosed device can be used for training of eye muscles through appropriate medical recommendations.

The stated objectives of this invention are being achieved in its four embodiments.

The first embodiment of the refractometer comprises a focusing optical element optically aligned with a test-object, and a measuring element. The test-object is arranged in the focal plane of the focusing optical element. The test-object and/or focusing optical element are movable relatively to each other along the optical axis, and positioning of the test-object in the focal plane of the focusing optical element corresponds to the normal vision and is assigned to the starting point on a readout scale of the measuring element. It is preferable that the test-object consist of at least two separate test-objects, including changeable test-objects, placed at a small distance from each other along the optical axis, and the readout value on the measuring element be taken only at a clear image of one of the test-objects. The focusing optical element is preferably made as a collimator objective. The focusing optical element can also be a focusing lens. Or the focusing optical element can be a concave mirror.

A preferable measuring element is a measuring scale. Furthermore, the measuring scale can be graduated in dioptres. And the graduation of the measuring scale in dioptres is determined by formula x=f/(1−fN), where f is a focal length of the focusing optical element, N is a signed value of dioptres marked on the measuring scale, x—is corresponding to N distance from the focusing optical element to a test-object.

The measuring element can be also made as a displacement sensor.

It is preferable to introduce to the measuring element an additional, second measuring scale. And to graduate the second measuring scale in millimeters for measuring distance between the eye pupils.

It is preferable that the focusing optical element can be equipped by a set of removable cylindrical and/or spherical lenses. In addition, the cylindrical lenses of the set of changeable lenses are rotatably mounted on the focusing optical element and can be rotated around an optical axis. It is preferable that the refractometer contains an additional scale to measure main meridian angles of an astigmatic eye.

A test-object used to determine visual acuity can show graphical objects of different angular dimensions. Additionally, the test-object can be made with use of color elements for testing color sensitivity.

The second embodiment of the refractometer comprises a focusing optical element optically aligned with a test-object arranged in the focal plane of the optical focusing element, and also a measuring element, and an additional introduced optical member attached to the test-object and the measuring element for a joint movement along the optical axis, while positioning of the test-object in the focus plane of the focusing optical element corresponds to the normal vision and coincides with the readout start point of the measuring element. It is preferable that a test-object has at least two separate test-objects, including changeable test-objects, placed at a small distance from each other along the optical axis, and the readout value on the measuring element is taken when only one of the test-object seeing clear.

The focusing optical element is preferably a collimator objective. The focusing optical element can also be a focusing lens. Also, the focusing optical element can be a concave mirror.

The introduced optical member is preferably a deflecting prism changing the direction of an optical axis at an angle about 90 degrees. Also, the introduced optical member can be made as a mirror for changing the direction of the optical axis at an angle about 90 degrees.

A preferable measuring element is a measuring scale. Furthermore, the measuring scale can be graduated in dioptres. And the graduation of the measuring scale in dioptres is determined by formula x=f/(1−fN), where f is a focal length of the focusing optical element, N is a signed value of dioptres marked on the measuring scale, x—is corresponding to N distance from the focusing optical element to the test-object.

The measuring element can also be made as displacement sensor. It is preferable to add a second measuring scale to the measuring element and to graduate the second measuring scale in millimeters for measuring a distance between the eye pupils. It is preferable that the focusing optical element can be equipped by a set of removable cylindrical and/or spherical lenses. In addition, the cylindrical lenses of the set of the changeable lenses are rotatably mounted on the focusing optical element and can be rotated around the optical axis. It is preferable that the refractometer contains an additional scale to measure angels of the main meridians of an astigmatic eye. A test-object, being used to determine visual acuity, can show graphical objects of different angular dimensions. Additionally, the test-object can be made with use of color elements for testing color sensitivity.

The third embodiment of the refractometer comprises a focusing optical element aligned with a test-object arranged in the focal plane of the optical focusing element, a measuring scale, and movable along the optical axis optical member, introduced between the focusing optical element and the test-object, whereas the focusing optical element and the optical member are inside refractometer housing, but the measuring scale is placed stationary on the test-object located on the outside of refractometer housing. Positioning of the test-object in the focal plane of the focusing optical element corresponds to the normal vision and coincides with the readout start of the measuring element. It is preferable that the test-object consist of at least two separate test-objects, including changeable ones, placed at a small distance from each other along the optical axis, and the readout value on the measuring element is taken only when one of test-objects seeing clear.

The focusing optical element is preferably a collimator objective. The focusing optical element can also be a focusing lens. Also, the focusing optical element can be a concave mirror.

The added optical member is preferably a deflecting prism for changing the direction of optical axis at an angle about 90 degrees. Also, the added optical member can be made as a mirror for deflecting the direction of the optical axis at an angle about 90 degrees. Furthermore, the measuring scale can be graduated in dioptres. And the graduation of the measuring scale in dioptres is determined by formula x=f/(1−fN), where f is a focal length of the focusing optical element, N is a signed value of dioptres on the measuring scale, x—is corresponding to N distance from the focusing optical element to a test-object.

It is preferable that the focusing optical element can be equipped by a set of removable cylindrical and/or spherical lenses. In addition, the cylindrical lenses of the set of changeable lenses are rotatably mounted on the focusing optical element and can be rotated around the optical axis. It is preferable that the refractometer contains an additional scale to measure angles of the main meridians of an astigmatic eye. A test-object to determine visual acuity can show graphical objects of different angular sizes. Additionally, the test-object can be made with use of color elements for testing color sensitivity.

The fourth embodiment of the refractometer comprises a focusing optical element, a test-object, and a measuring scale, but the test-object is made extended along an optical axis, while the focusing optical element and the test-object are stationary, and the test-object contains the measuring scale as well as a plurality of N tests placed at predetermined distance along the optical axis, and one of N tests is located in the focal plane of the focusing optical element and coincides with the readout start of the measuring element, thus corresponding to the normal vision.

Preferably, the focusing optical element is a collimator objective. The focusing optical element can also be a focusing lens. Also, the focusing optical element can be a concave mirror.

Furthermore, the measuring scale can be graduated in dioptres. And the graduation of the measuring scale in dioptres is determined by formula x=f/(1−fN) where f is a focal length of the focusing optical element, N is a signed value of dioptres on the measuring scale, x is a distance from the focusing optical element, corresponding to a given test.

It is preferable that the focusing optical element be equipped by a set of removable cylindrical and/or spherical lenses. In addition, the cylindrical lenses in the set of changeable lenses are rotatably mounted on the focusing optical element and can rotate around the optical axis. It is preferable that the refractometer contains an additional scale to measure main meridian angles of an astigmatic eye. At least one of N tests has graphical objects of different angular dimensions to determine visual acuity. And at least one of N tests is made with use of color elements for testing color sensitivity.

General Theory of Operation

The essence of the invention is simple and is based on the eye physiology—the ability to focus images of far and near objects on the retina, i.e. accommodation. A special point exists, where the eye crystalline lens is completely relaxed. In such a case a normal eye, i.e. emetropic, focuses parallel rays exactly on the retina (FIG. 1a), a nearsighted eye, i.e. myopic, focuses divergent rays on the retina (FIG. 1b), and a farsighted eye, i.e. hyperopic, focuses converging rays (FIG. 1c). These limiting parameters of both divergent and convergent rays define deviations from a normal vision and dioptres of corrective lenses, that is referred as “a refractive error”.

Therefore, changing the mutual arrangement of the test-object and the focusing optical element, it is possible to imitate the image of the test-object in converging or diverging rays on the eye retina (i.e. for hyperopia or myopia), and by using measuring scales, connected to the test-object and/or to the focusing optical element, it is possible directly to determine in dioptres required correction for patient's eyes.

### BRIEF DESCRIPTION OF THE DRAWINGS

The invention is explained by an example of the preferable embodiment with references to the following figures:

FIG. 1a—is a schematic representation of rays coming exactly on the eye retina for a normal vision.

FIG. 1b—is a schematic representation of rays coming on the eye retina in a myopic eye.

FIG. 1c—schematically presents rays coming on the eye retina in a hyperopic eye.

FIG. 2—schematically presents a prior art refractometer.

FIG. 3—schematically presents the first embodiment of a disclosed refractometer (Milanich's tester) according to the present invention.

FIG. 4—schematically presents the second embodiment of the refractometer (Milanich's tester) according to the present invention.

FIG. 5—is a schematic representation of the third embodiment of the refractometer (Milanich's tester) according to the present invention.

FIG. 6—is a schematic representation of the fourth embodiment of the refractometer (Milanich's tester), according to the present invention.

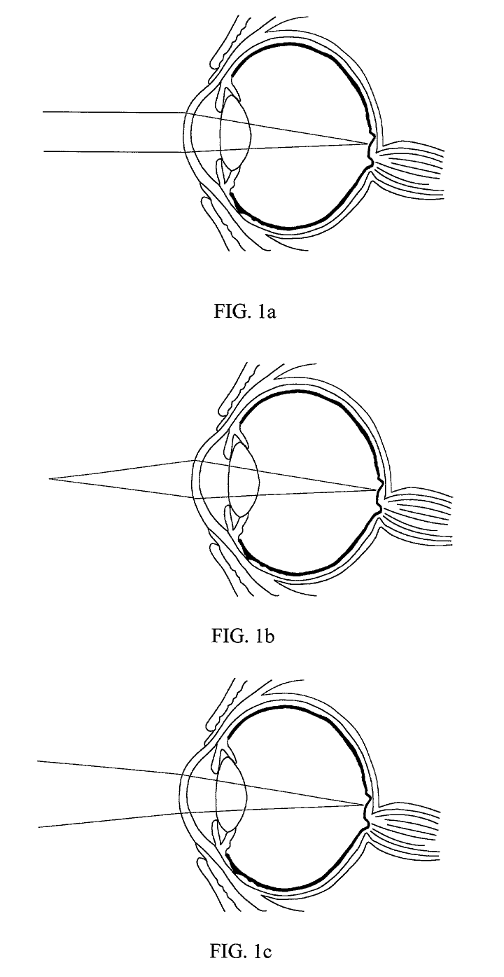

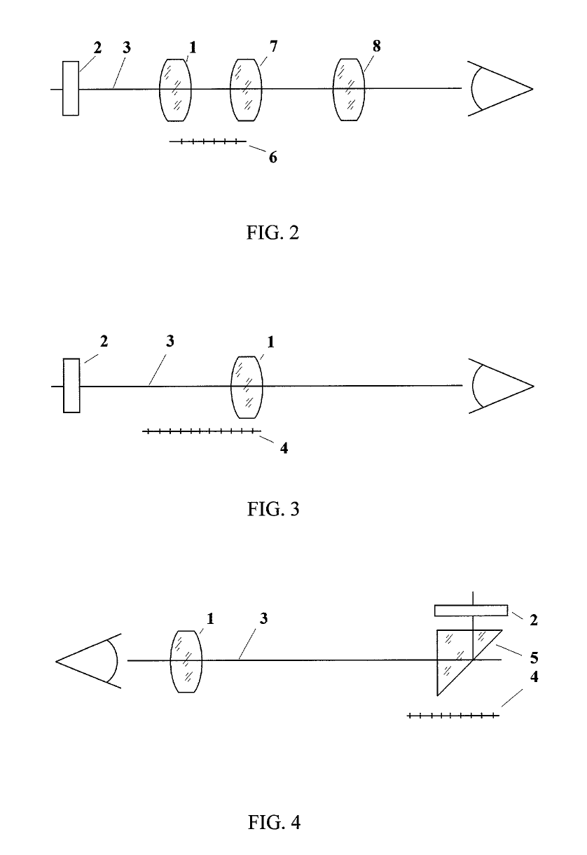

### DESCRIPTION OF THE PREFERRED EMBODIMENT

The first embodiment of the refractometer, schematically presented on FIG.3, contains a focusing optical element 1, optically aligned with a test-object 2, an optical axis 3, and also a measuring element 4. For a case of the normal vision the test-object would be located in a focal plane of the focusing optical element. The test-object and the focusing optical element are movable relative to each other along the optical axis. The measuring element 4 measures a distance between the focusing optical element 1 and the test-object 2.

Within the description of the disclosed invention, we shall mean as mutual displacement of the focusing optical element 1 and the test-object 2 along the optical axis, the following cases of possible movements:

The focusing optical element is stationary and the test-object is movable along the optical axis.

The test-object is stationary and the focusing optical element is movable along the optical axis.

The focusing optical element and the test-object are movable along an optical axis.

The measuring element 4 can be a displacement sensor to convert a displacement of a movable member (a test-object or an objective) to a diopter value of a correcting lens (refractive error). It is not essential how the conversion is carried out or how the measuring scale of the displacement sensor is implemented.

The measuring element can be a potentiometer with a digital indicator, converting displacement of a movable element (the test-object or the objective) to a control signal, and further converting to a value of dioptres, to be displayed on the digital indicator.

The measuring element can be implemented as a variable resistance modifying changes in a distance between the test-object and the objective and transforming corresponding resistance value to dioptres of a corrective lens (refractive error), etc.

In the simplest design, the measuring element is a stationary scale on a device housing, and refractive error is measured against the scale by displacing the movable member (the test-object and/or the focusing optical element).

It is possible to assign a numeric value, corresponding to a distance between the focusing optical element and the test-object, as a function of dioptres of needed corrective lens for correcting patient's refractive errors. The graduation of the scale in dioptres can be carried out, for example, by calculation using the thin lens formula:

1/x+1/b=1/f (1),

where f is a focal length of a focusing optical element, x is a distance between the focusing optical element and the test-object, b is a distance from the focusing optical element to the test-object's image. According to the formula (1) it is possible to recalculate distance x to appropriate value of dioptres and to graduate the scale in dioptres as follows:

x=f/(1−fN) (2),

where N is a positive or negative value of dioptres on a scale, x is corresponding to this N measured distance from the focusing optical element to the test-object. In the case of a thick lens the formula will have insignificant modifications. The sign plus corresponds to farsightedness and the minus to nearsightedness. The location of the test-object exactly in a focus of the focusing optical element corresponds to the normal vision and to zero on the scale that is also reflected by the formula.

The formula applies as follows. For example, we want to graduate a scale by values 1, −4, and 2.7. By substituting each of the values, taking into account the sign, to the formula (2), we'll obtain corresponding to the given diopter a distance between the lens and the test-object, then we'll mark the scale at this distance with the given diopter value.

The scale of a measuring element can be made as a graduated ruler, a digital liquid crystal panel, or a light emitting diode indicator, etc.

To measure a distance between the pupils, it is possible to add to the refractometer a second scale graduated in millimeters in the range from 50 to 85 mm (most people have the distance between the pupils about 65 mm), which would span a distance between the pupils in majority of population, both for children and adults. In addition, on the movable and stationary parts of the refractometer, it is preferable to make two apertures of 0.2-2 mm in diameter, and the distance (in millimeters) between the centers of these two apertures would precisely correspond to the second scale. The diameter of apertures determines the accuracy of this measurement. 1 mm accuracy is required for glasses manufacturing. A patient can determine the distance between the pupils as readout on the second scale at the moment when he clearly see a far object, approaching the apertures to the eyes and considering any far object through these two apertures by the right and left eyes simultaneously, and displacing the apertures relatively to each other.

Thus using the described device, a patient or a doctor can completely carry out measurements necessary for glasses manufacturing.

The focusing optical element 1, (FIG. 3-FIG. 6) can be a collimator objective, a focusing lens, or a concave mirror. It is obvious that a collimator objective allows forming better images. However, using a focusing lens or a concave mirror as the optical element for forming an image in the disclosed refractometer, would significantly reduce the cost of the device without loss its functionality.

The collimator objective, the focusing lens and the concave mirror can be provided with a set of changeable lenses having various cylindrical and/or spherical surfaces. The lenses with a cylindrical surface are rotatably mounted on the collimator objective and can rotate around the optical axis, whereby allowing somebody to determine the main astigmatism meridians of an eye and testing an astigmatic eye.

The astigmatism measured by a set of removable lenses requires a rotary scale to measure an angle, corresponding to a turning angle of the axis of the cylindrical lens at the point where the astigmatism is compensated.

In addition, using a set of removable lenses adopted the disclosed refractometer to a specific person, making it especially convenient for a myopic vision.

Mounting a removable lens as an additional optical member on the collimator objective, focusing lens, or on the concave mirror, that does not necessarily require recalculation and new scale graduation, according to the already described technique, because the new scale can be graduated in relative units and serve to increase an accuracy of relative changes in vision parameters.

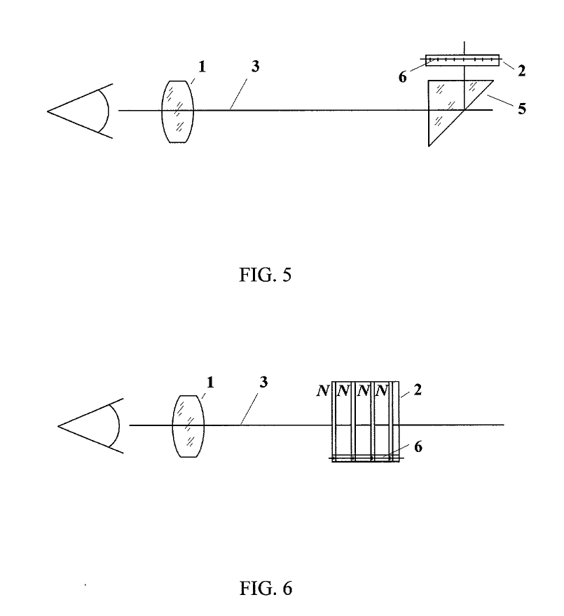

The increase of the accuracy in determining vision parameters is implemented by making the test-object 2 (FIG. 3, FIG. 4, FIG. 5, and FIG. 6) consisting from at least two test-objects (not shown on the drawings), including changeable objects, placed along the optical axis 3 at some distance from each other.

By choosing a distance between the test-objects according to the formula (2), and recognizing that this distance corresponds, for example, to 0.3 diopter at the test-object's position corresponding to the normal vision, the patient has an opportunity to determine parameters of the eye with accuracy better than 0.3 diopter for a farsightedness and worse than 0.3 diopter for nearsightedness. The readout on the scale is made when only one of the test-objects is clearly seen, and the graduation of the scale is carried out only for that one test-object.

In the case of using a removable lens (not shown on the drawings), it is preferable to add one more test-object or to use mountable, changeable test-objects. This is related to the fact that with increasing the distance between a test-object and the focusing optical element, it makes sense to increase a gap between two test-objects or, if not changing the gap between two test-objects, to add a third (next) test-object.

That is optimal to change a gap separating one test-object from the next one, by degree of increasing the distance between the test-object and the focusing optical element.

Images placed on the test-object allow customizing a refractometer for various groups of patients. For preschool-age children test-objects can include subjects familiar to young children (animals, toys, etc.), that will allow carrying out testing more effectively. For people with low visual acuity, the test-object can be made of larger figures.

For checking visual acuity, it is possible to show on the test-object graphical objects of different angular dimensions, for example, corresponding to predefined angular sizes as follows: one angular minute—1, a half angular minute—2, two angular minutes—0.5, etc. Arranging on the test-object elements of larger and smaller angular dimensions, it is possible to test deviation of visual acuity in a required range. If an angular dimension of observed element on the test-object is near to normal vision acuity, (corresponding to one angular minute in the range of measurements), and a patient distinguishes this element, that indicates his normal vision acuity. The simplest kinds of such elements are alternating strips separated by different distances between them. Vision acuity is not tested in all area of the retina, but near to zone having the greatest vision acuity.

Use of color elements in a test-object allows checking deviations of a patient's color sensitivity. The tests themselves can be the standard tests for color blindness determination. Using changeable color test-objects allows checking the eye color sensitivity in various ranges of spectrum.

The second embodiment of the refractometer, schematically shown on FIG. 4, comprises of a focusing optical element 1, a test-object 2, an optical axis 3, a measuring element 4, an optical member 5. The test-object 2 is arranged in the focal plane of the focusing optical element 1, and the optical member 5, located between the focusing optical element 1 and the test-object 2, is attached to the test-object and the measuring element 4 with the possibility of their movement along the optical axis 3, thus the position of the test-object 2 in the focal plane of the focusing optical element 1 corresponds to the normal vision and coincides with the start readout of the measuring element.

Within the description framework of the second embodiment of the disclosed device, as mutual displacement of the focusing optical element 1 and the test-object 2, having the optical member 5 and the measuring element 4, is understood to be similar to possibilities listed in first embodiment of the refractometer.

Examples of the realization of the measuring element, the focusing optical element, and the test-object similar to corresponding examples described in the first embodiment of the refractometer.

The optical member 5 (FIG. 4), introduced in the second embodiment of the refractometer, can be a deflecting prism, or a mirror, or the optical member can be realized as a system of lenses and mirrors, that allows viewing by a patient results of measuring vision parameters. However, vision parameters can be hidden from a patient and remain accessible for a doctor only.

Another important advantage of implementing the invention according to the second embodiment with a deflection of the optical axis 3 (FIG. 4) is a possibility to reduce significantly refractometer's dimensions. In addition, this design allows easier replace the test-objects 2, what is important in several types of tests, for example, in testing color sensitivity.

FIG. 5 schematically presents the third embodiment of the refractometer comprising a focusing optical element 1, a test-object 2, an optical axis 3, a measuring scale 6, an optical member 5, housing (not shown on the drawings), wherein the test-object 2 is arranged in the focal plane of the focusing optical element 1, and the optical member 5 has moving ability along the optical axis 3, whereas the optically aligned focusing optical element 1 and the optical member 5 are located inside the device housing while the measuring scale 6 is placed on the test-object 2 stationary attached on the housing, thus a position of the test-object 2 in the focal plane of the focusing optical element 1 corresponds to the normal vision, coinciding with the readout start on the measuring scale 6. Moreover, the focusing optical element 1 can be supplied with a set of removable lenses having various cylindrical and/or spherical surfaces and a scale (not shown in the drawings.).

The fourth embodiment of the refractometer (FIG. 6), comprises a continuous test-object 2 containing N tests, each of N tests is placed at a predefined distance along the optical axis 3 and measuring scales 6, wherein one of the N tests of the test-object 2 is placed in the focal plane of the focusing optical element 1 and is positioned against the readout start on the measuring scale 6, what corresponds to the normal vision. Placing each of N tests at a predefined distance along the optical axis is done according to formula (2). And the focusing optical element 1 can be additionally equipped with a set of removable lenses of various cylindrical and/or spherical surfaces, and a scale (not shown on the drawing).

Refractometer Operation

The refractometer of the first embodiment works as follows. As it has been already described, under a mutual displacement of the focusing optical element and the test-object, within the framework of the description of the disclosed device, we understand possible movements of device's elements along an optical axis as follows:

The focusing optical element is stationary, the test-object moves along the optical axis.

The test-object is stationary, the focusing optical element moves along the optical axis.

The focusing optical element and the test-object are movable along the optical axis.

There are many variants to realize the mutual displacement of the focusing optical element and the test-object in described embodiments of the device, even though it does not have principle importance which element moves, because only the distance between the focusing element and the test-object determines the device operation. The operation of the device will be explained in the case, when the focusing optical element is stationary and the test-object moves along the optical axis. Variants when a test-object is stationary, but a focusing optical element is movable, and when both the test-object and the focusing optical element move, not described as the device operation does not really changes in comparison with the described variant.

Referring to FIG. 3, the test-object 2 can be moved along the optical axis 3 starting from a maximally distant position up to some minimal distance, determined by the design and dimensions of the device housing.

After establishing the greatest possible distance between the test-object 2 and the focusing optical element 1, the patient begins slowly to reduce this distance. It causes decrease in the readout value on the measuring element 4 from the maximal values toward minimal values. At some moment the patient will see a clear image of the test-object. That first distance corresponds to a completely relaxed condition of the eye crystalline lens, and corresponds to certain readout on the measuring element and some dioptres of a corrective lens. The location of the test-object 2 exactly in the focal plane of the focusing optical element 1, in all embodiments of the refractometer, corresponds to the normal vision, as it has been previously explained, and corresponds to the readout start of the measuring element, or value “0” for measuring scale.

By continuing to decrease the distance between the test-object and the focusing optical element, we'll determine the second distance where the patient can not clearly see the test-object. The difference between the first and the second values (in dioptres) indicated by the measuring element is the range (value) of eye accommodation.

When the refractometer works with a removable lens mounted on the focusing optical element, the accuracy of measurement of eye accommodation increases, i.e. accuracy of measuring refractive error increases. As the optical power of such compound optical element has changed, according to the method of computation by formula (2), it is always possible to choose a focal length of the removable lens so, that the distance corresponding to relax crystalline lens would increase (even insignificantly). The optimal distance will be more than ⅔ from the maximum distance, but less than the maximum distance, as if we make it precisely equal to the maximum distance allowable by a device design, we can count changes in vision only in one direction. If assumed range of fluctuations of vision parameters is known, the distance can be equal to the greatest possible distance, minus distance corresponding to the range of these fluctuations. Increasing the distance allows to increase the accuracy of the measurement of vision parameters, which is important in monitoring the small seasonal or temporary fluctuations of vision parameters. In a device geared to nearsightedness, it is appropriate to place a zero of the scale at a distance ⅔ of the maximal distance. The removable lens allows additional adopting a typical device to some person, especially when the person's vision corresponds to a case of strong nearsightedness. It is true, that a system with the removable lens will have a new scale, that can be located, for example, below the main scale, and in the case of a non mechanical display it will simply corresponds to the same dioptres, but at another distance between the objective and the test-object. It is not necessary to perform a new graduation of the scale. This scale can be graduated in relative units.

It allows, also, the astigmatism measuring, by using the removable lens with a cylindrical surface precisely compensating astigmatism of the eye. For this purpose it is necessary to have a set of cylindrical lenses, with various focal lengths, and a scale (not shown in the drawing) for determining an angular of the lens rotation, around its optical axis. At some distance between the test-object and the focusing optical element, where the eye distinguishes the test, we fix a refractometer position and mount on the objective a removable cylindrical lens and begin slowly to rotate the cylindrical lens around its axis in arbitrary direction. And the patient tries to determine an angle of turn of the lens, where the test-object is seen most clearly. Repeating this procedure with various cylindrical lenses, we select the lens that gives the best subjective image. It occurs only at one angle of turn of the axis of the cylindrical lens respecting to the vertical axis, and hence, the focal length of the cylindrical lens, and this angle, completely define parameters of the astigmatic eye.

The given technique for the astigmatism definition is identical in any implementation of further described devices.

The technique for checking visual acuity and color sensitivity is also identical to any of the refractometer embodiments submitted in the description.

Control of visual acuity consists in determination of minimal angular dimensions presented on the test-object.

Color sensitivity is controlled by patient's ability to distinguish similar color palette images represented on the test-object in various spectral ranges.

The refractometer of the second embodiment (FIG. 4) works as follows. The focusing optical element 1 is fixed and the test-object 2 together with the optical member 5 and measuring element 4 are movable along the optical axis. The test-object 2 together with the optical member 5 and measuring element 4 can move along the optical axis from the most distant possible location, restricted by the device housing dimension, up to some minimal distance to the focusing optical element. By moving the optical member 5, the test-object 2 and the measuring element 4 the patient fixes their position where for the first time has clearly seen the test-object 2. The value of dioptres corresponding to this position defines a refractive error. Then, continuing to approach the optical member 5 together with the test-object 2 and the measuring element 4, the patient takes a notice of the position and corresponding dioptres at which the patient has clearly seen the test-object for the last time. The difference between this value and the refractive error determined previously corresponds to eye accommodation range.

The techniques for measuring other vision parameters are similar to the techniques described in the first embodiment of the device and are obvious to the specialist in the art, therefore, will not be presented in the description.

Let us consider the third embodiment of the refractometer (FIG. 5). We consider a variant in which the optically aligned focusing optical element 1 and the optical member 5 are located inside housing (not shown on the drawing), and the optical member 5 can move along the optical axis, and the measuring scale 6 placed on the stationary attached to housing test-object 2. The optical member 5 can move along the optical axis from the most distant location, restricted by the housing design and its dimension, up to the some minimal distance respectively.

The measurement philosophy of vision parameters is similar as described elsewhere in this text, i.e. in the first and second embodiments of the invention, and is obvious to the specialist in the art, and, therefore, will not be repeated in the description, with the only difference, that patient consistently sees (and fixates the location of optical member 5) different areas of the same test-object and the scale on the test-object. And due to limitation in the eye accommodation range, the patient clearly sees only that part of the test-object and of the scale that corresponds in dioptres to the range from “refractive error” to “refractive error+eye accommodation range”. It makes vision measurements more observable.

For the device of the forth embodiment (FIG. 6), the technique differs slightly as this device does not have a movable element. In this embodiment of the refractometer a patient simply determines the most distant test from the optical focusing element 1 that the patient can clearly see. It is the test, out of N tests of the test-object 2, corresponding to a condition of relaxed crystalline lens, and to a maximal value of dioptres on the scale 6, placed on the test-object 2. The patient sees an appropriate value of dioptres simultaneously with the test-object, because a measuring scale 6 is located on the continuous test-object. Similarly, the patient tries to notice the closest clearly seen test out of N tests comprising the continuous test-object 2, i.e., the patient simultaneously observes, on the measuring scale 6 corresponding dioptres. The difference between the most distant and the nearest values of dioptres, as was explained previously, is the range of accommodation.

Determination of other vision parameters coincides with similar procedures described in the work of the first embodiment of the invention, except measuring the distance between the pupils, that is impossible in this last embodiment of the refractometer.

Commercial Relevance

The disclosed refractometer can be used as a simple vision tester to obtain objective data about patient's vision. Thus, installing on the scale predefined dioptres, makes an opportunity to establish a predetermined load on the muscle deforming the eye crystalline lens. This creates an opportunity to train the crystalline lens muscle and to correct the vision. All this, alongside with simplicity and low cost, makes the disclosed tester very useful for a widespread use by both specialists and public.

I claim:

1. A refractometer comprising: a measuring element, a focusing optical element optically aligned with a test-object, and a test-object arranged in a focal plane of a focusing optical element, wherein a test-object and/or a focusing optical element having ability for mutual displacement along an optical axis; and positioning of the test-object in a focal plane of a focusing optical element corresponds to the normal vision and coincides with a readout start of a measuring element.

2. The refractometer as claimed in claim 1, wherein a test-object consist of at least two test-objects, including changeable test-objects, and test-objects are placed at a small distance from each other along an optical axis, and a readout of a measuring element is taken under condition when only one of test-objects objects is seen clearly.

3. The refractometer as claimed in claim 1, wherein a focusing optical element is a collimator objective.

4. The refractometer as claimed in claim 1, wherein a focusing optical element is a focusing lens.

5. The refractometer as claimed in claim 1, wherein a focusing optical element is a concave mirror.

6. The refractometer as claimed in claim 1, wherein a measuring element is a measuring scale.

7. The refractometer as claimed in claim 6, wherein a measuring scale is graduated in dioptres.

8. The refractometer as claimed in claim 7, wherein a measuring scale is graduate in dioptres according to the formula x=f/(1−fN),
where f is a focal length of a focusing optical element, N is a signed diopter value marked on a measuring scale, x is, corresponding to N, distance from a focusing optical element.

9. The refractometer as claimed in claim 1, wherein a measuring element is a displacement sensor.

10. The refractometer as claimed in claim 6, wherein a measuring element additionally includes a second measuring scale.

11. The refractometer as claimed in claim 10, wherein a second measuring scale, graduated in millimeters, for measuring a distance between eye pupils.

12. The refractometer as claimed in claim 1, wherein a focusing optical element is additionally equipped with a set of removable lenses having different cylindrical and/or spherical surfaces.

13. The refractometer as claimed in claim 12, wherein, removable lenses having a cylindrical surface are rotatably mounted on a focusing optical element with a possibility of rotation around an optical axis.

14. The refractometer as claimed in claim 12 or in claim 13, wherein it contains an additional scale for determination of an angle of main meridians of an astigmatic eye.

15. The refractometer as claimed in claim 2, wherein a test-object contains graphical objects of different angular dimensions for measuring visual acuity.

16. The refractometer as claimed in claim 2, wherein a test-object contains color elements for testing color sensitivity.

17. A refractometer comprising: a measuring element, a focusing optical element optically aligned with a test-object, and a test-object arranged in a focal plane of a focusing optical element, wherein an optical member is introduced between a focusing optical element and a test-object, and an optical member being joined with a test-object and a measuring element to be movable together along an optical axis; and positioning of a test-object in a focal plane of a focusing optical element corresponds to the normal vision and coincides with a readout start of a measuring element.

18. The refractometer as claimed in claim 17, wherein a test-object consist of at least two test-objects, including changeable test-objects, and test-objects are placed at a small distance from each other along an optical axis, and a readout of a measuring element is taken under condition when only one of test-objects is seen clearly.

19. The refractometer as claimed in claim 17, wherein a focusing optical element is a collimator objective.

20. The refractometer as claimed in claim 17, wherein a focusing optical element is a focusing lens.

21. The refractometer as claimed in claim 17, wherein a focusing optical element is a concave mirror.

22. The refractometer as claimed in claim 17, wherein an optical member is a deflecting prism for changing direction of an optical axis to an angle of about 90 degrees.

23. The refractometer as claimed in claim 17, wherein an optical member is a mirror for changing direction of an optical axis to an angle of about 90 degrees.

24. The refractometer as claimed in claim 17, wherein a measuring element is a measuring scale.

25. The refractometer as claimed in claim 24, wherein a measuring scale is graduated in dioptres.

26. The refractometer as claimed in claim 25, wherein graduation of a measuring scale in dioptres is determined by the formula x=f/(1−fN), where f is a focal length of a focusing optical element, N is a signed value of dioptres on a measuring scale, x is, corresponding to N, distance from a focusing optical element.

27. The refractometer as claimed in claim 17, wherein a measuring element is a displacement sensor.

28. The refractometer as claimed in claim 24, wherein a measuring element additionally includes a second measuring scale.

29. The refractometer as claimed in claim 28, wherein a second measuring scale, graduated in millimeters, for measuring the distance between eye pupils.

30. The refractometer as claimed in claim 17, wherein a focusing optical element is additionally equipped with a set of removable lenses having different cylindrical and/or spherical surfaces.

31. The refractometer as claimed in claim 30, wherein removable lenses having a cylindrical surface are rotatably mounted on a focusing optical element with possibility of rotation around an optical axis.

32. The refractometer as claimed in claim 30 or in claim 31, wherein it contains an additional scale for determination of an angle of main meridians of an astigmatic eye.

33. The refractometer as claimed in claim 18, wherein a test-object contains graphical objects of different angular dimensions for measuring visual acuity.

34. The refractometer as claimed in claim 18, wherein a test-object contains color elements for testing color sensitivity.

35. A refractometer comprising: a focusing optical element, a test-object and a measuring scale, and a test-object is arranged in a focal plane of a focusing optical element, wherein an optical member is introduced between a focusing optical element and a test-object, and an optical member having ability for displacement along an optical axis; and a focusing optical element and an optical member are optically aligned and located inside of housing; but a measuring scale is located on a test-object, stationary located on housing, and positioning of a test-object in a focal plane of a focusing optical element corresponds to the normal vision and coincides with a readout start of a measuring scale.

36. The refractometer as claimed in claim 35, wherein a test-object consist of at least two test-objects, including changeable test-objects, and test-objects are placed at a small distance from each other along an optical axis, and a readout of a measuring scale is taken under condition when only one of test-objects is seen clearly.

37. The refractometer as claimed in claim 35, wherein a focusing optical element is a collimator objective.

38. The refractometer as claimed in claim 35, wherein a focusing optical element is a focusing lens.

39. The refractometer as claimed in claim 35, wherein a focusing optical element is a concave mirror.

40. The refractometer as claimed in claim 35, wherein an optical member is a deflecting prism for changing direction of an optical axis to an angle of about 90 degrees.

41. The refractometer as claimed in claim 35, wherein an optical member is a mirror for changing direction of an optical axis to an angle of about 90 degrees.

42. The refractometer as claimed in claim 35, wherein a measuring scale is graduated in dioptres.

43. The refractometer as claimed in claim 42, wherein a measuring scale is graduate in dioptres according to the formula x=f/(1−fN),
where f is a focal length of a focusing optical element, N is a signed diopter value marked on a measuring scale, x is, corresponding to N, distance from a focusing optical element.

44. The refractometer as claimed in claim 35, wherein a focusing optical element is additionally equipped with a set of removable lenses having different cylindrical and/or spherical surfaces.

45. The refractometer as claimed in claim 44, wherein, removable lenses having a cylindrical surface are rotatably mounted on a focusing optical element with possibility of rotation around an optical axis.

46. The refractometer as claimed in claim 44 or in claim 45, wherein it contains an additional scale for determination of an angle of main meridians of an astigmatic eye.

47. The refractometer as claimed in claim 36, wherein a test-object contains graphical objects of different angular dimensions for measuring visual acuity.

48. The refractometer as claimed in claim 36, wherein a test-object contains color elements for testing color sensitivity.

49. A refractometer comprising: a focusing optical element; a test-object; and a measuring scale, wherein a test-object is extended along an optical axis, and a focusing optical element and a test-object are stationary, and a test-object has a measuring scale and a plurality of N tests, each of said N tests is placed at a preliminary determined distance along an optical axis, whereas one of N tests is placed in a focal plane of a focusing optical element and coincides with a readout start of a measuring scale and corresponds to the normal vision.

50. The refractometer as claimed in claim 49, wherein a focusing optical element is a collimator objective.

51. The refractometer as claimed in claim 49, wherein a focusing optical element is a focusing lens.

52. The refractometer as claimed in claim 49, wherein a focusing optical element is a concave mirror.

53. The refractometer as claimed in claim 49, wherein a measuring scale is graduated in dioptres.

54. The refractometer as claimed in claim 49, wherein a measuring scale is graduate in dioptres according to the formula x=f/(1−fN),
where f is a focal length of a focusing optical element, N is a signed diopter value marked on a measuring scale, x is a distance from a focusing optical element, corresponding to this test.

55. The refractometer as claimed in claim 49, wherein a focusing optical element is additionally equipped with a set of removable lenses having different cylindrical and/or spherical surfaces.

56. The refractometer as claimed in claim 55, wherein removable lenses having a cylindrical surface are rotatably mounted on a focusing optical element with possibility of rotation around an optical axis.

57. The refractometer as claimed in claim 55 or in claim 56, wherein it contains an additional scale for determination of an angle of main meridians of an astigmatic eye.

58. The refractometer as claimed in claim 49, wherein at least one of N tests contains graphical objects of different angular dimensions for measuring visual acuity.

59. The refractometer as claimed in claim 49, wherein at least one of N tests contains color elements for testing color sensitivity.
